(19) United States
(12) Patent Application Publication
(10) Pub. No.: US 2004/0244908 A1
(43) Pub. Date: Dec. 9, 2004

(54) Method for packing transparent layers for image sensor packages

(76) Inventor: Chung Hsien Hsin, Hsinchu Hsien (TW)

Correspondence Address: PRO-TECHTOR INTERNATIONAL, 20775 Norada Court, Saratoga, CA, 95070-3018, US

(21) Appl. No.: 10/454,650

(22) Filed: Jun. 3, 2003

(51) Int. Cl. B32B 31/00

(52) U.S. Cl. 156/292

(57) ABSTRACT

A method for packing transparent layers for image sensor packages of the invention includes the steps of: providing a plurality of clean transparent layers; placing the plurality of clean transparent layers in a predetermined tray; providing a frame attached to a tape; adhering the tray carrying the plurality of transparent layers to the tape, which is further attached to the frame in advance, such that the transparent layers are adhered by the tape; and transporting the frame to which the transparent layers are adhered.

### BACKGROUND OF THE INVENTION

1. Field of the invention

The invention relates to a method for packing transparent layers for image sensor packages, and more particularly to a method for packing transparent layers without secondary contamination.

2. Description of the Related Art

A general sensor is used to sense signals, which may be optical or audio signals. The sensor of the invention is used to receive image signals or optical signals. After receiving the image signals, the sensor converts the image signals into electrical signals, which are then transmitted to a printed circuit board via a substrate.

Referring to FIG. 1, a conventional image sensor includes a substrate 10, a frame layer 12, a photosensitive chip 14, a plurality of wires 15, and a transparent layer 22. The substrate 10 has an upper surface 11 on which signal input terminals 18 are formed, and a lower surface 13 on which signal output terminals 24 are formed. The frame layer 12 is arranged on the substrate 10 to form a cavity 16 together with the substrate 10. The photosensitive chip 14 is arranged on the substrate 10 and within the cavity 16. A plurality of bonding pads 20 is formed on the photosensitive chip 14. The wires 15 electrically connect the bonding pads 20 of the photosensitive chip 14 to the signal input terminals 18 of the substrate 10, respectively. The transparent layer 22 is coated with an adhesive layer and arranged on the frame layer 12 to cover and encapsulate the photosensitive chip 14.

The packaged image sensor typically has to be tested to make its particles satisfy its quality requirement, and the cleanness of the transparent layer 22 greatly influences the quality of the image sensor. As shown in FIG. 2, after the cut transparent layers 22 are transported, the transparent layers 22 are usually placed in slots 28 that are formed in a lower tray 26 of a tray assembly 25 in advance, and then an upper tray 30 covers the lower tray 26. However, collision occurred during the transportation may damage or peel off the corners of the transparent layer 22, and the cleanness of the transparent layers 22 is influenced. Therefore, the transparent layers 22 have to be wiped and inspected again before the encapsulation thereof, thereby complicating the manufacturing processes and increasing the manufacturing cost.

### SUMMARY OF THE INVENTION

An object of the invention is to provide a method for packing transparent layers for image sensor packages, wherein the cleanness of the transparent layer may be kept and the manufacturing processes may be simplified.

Another object of the invention is to provide a method for packing transparent layers for image sensor packages, wherein the method may protect the transparent layer from collision so that the product yield may be increased.

To achieve the above-mentioned objects, the invention provides a method for packing transparent layers for image sensor packages including the steps of: providing a plurality of clean transparent layers; placing the plurality of clean transparent layers in a predetermined tray; providing a frame attached to a tape; adhering the tray carrying the plurality of transparent layers to the tape, which is further attached to the frame in advance, such that the transparent layers are adhered by the tape; and transporting the frame to which the transparent layers are adhered.

Thus, the tape may protect the transparent layers and protect the transparent layers from collision, damage, and secondary contamination. Thus, the manufacturing processes may be effectively simplified, and the manufacturing cost may be effectively reduced.

### BRIEF DESCRIPTION OF THE DRAWINGS

FIG. 1 is a schematic illustration showing a conventional image sensor package.

FIG. 2 is a schematic illustration showing a conventional method for packing transparent layers for image sensor packages.

FIG. 3 is a first schematic illustration showing the method for packing transparent layers for image sensor packages of the invention.

FIG. 4 is a second schematic illustration showing the method for packing transparent layers for image sensor packages of the invention.

FIG. 5 is a cross-sectional view of FIG. 4.

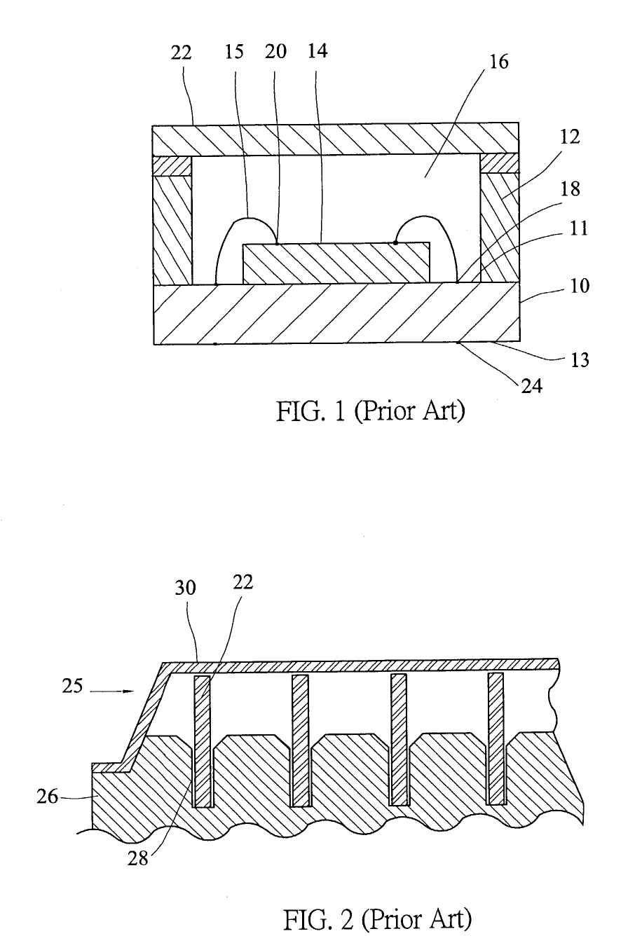

### DETAILED DESCRIPTION OF THE INVENTION

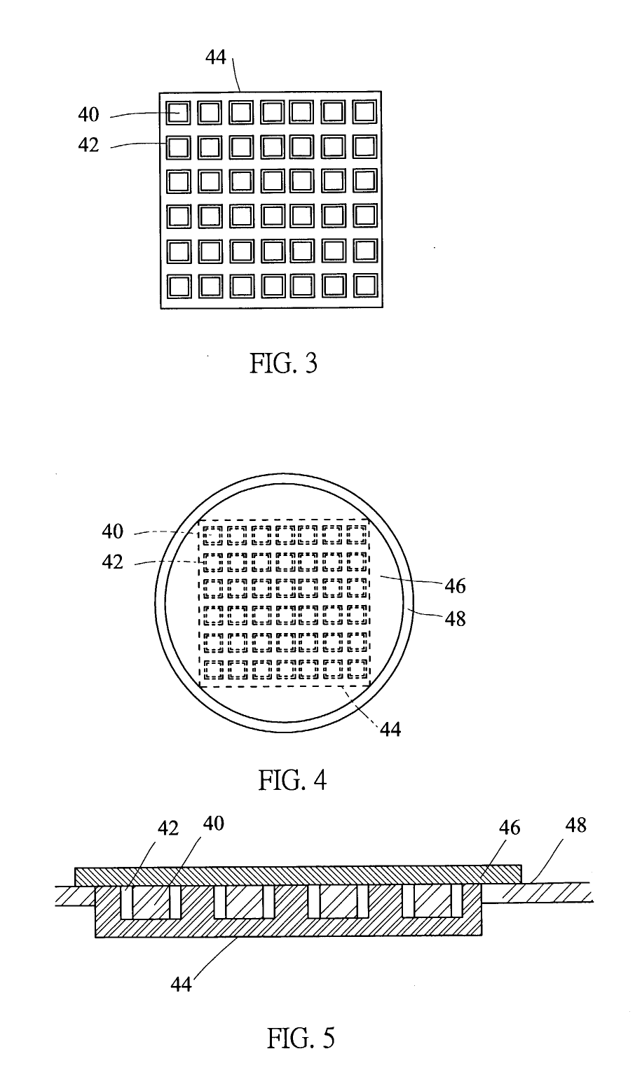

Referring to FIGS. 3 to 5, a method for packing transparent layers for image sensor packages of the invention includes the steps of:

wiping and inspecting a plurality of cut transparent layers 40, each of which is a piece of transparent glass in this embodiment;

providing a plurality of clean transparent layers 40;

placing the plurality of clean transparent layers 40 in a plurality of slots 42, which is formed in a tray 44 in advance, to expose the transparent layers 40 via the slots 42, respectively;

providing a frame 48 attached to a tape 46, as shown in FIGS. 4 and 5, wherein the frame 48 may be a conventional frame for wafer slicing; and

adhering the tray 44 carrying the plurality of transparent layers 40 to the tape 46, which is further attached to the frame 48 in advance. Thus, the tape 46 may adhere the plurality of transparent layers 40 and the tray 44 so as to protect the transparent layer 40 from damage, collision, and contamination during the transportation process.

When the image sensor is to be packaged, the frame 48 together with the tape 46 may be torn away from the tray 44, and the clean transparent layers 40 may be directly taken out for encapsulation without further wiping and inspecting the transparent layers 40. Consequently, it is possible to effectively simplifying the packaging processes for the image sensor, to prevent the transparent layers from being damaged, and to effectively reduce the manufacturing cost.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. A method for packing transparent layers for image sensor packages, comprising the steps of:
providing a plurality of clean transparent layers;
placing the plurality of clean transparent layers in a predetermined tray;
providing a frame attached to a tape;
adhering the tray carrying the plurality of transparent layers to the tape, which is further attached to the frame in advance, such that the transparent layers are adhered by the tape; and
transporting the frame to which the transparent layers are adhered.

2. The method according to claim 1, wherein each of the transparent layers is a piece of transparent glass.

3. The method according to claim 1, wherein the clean transparent layers are transparent layers having no particles after inspection.

4. The method according to claim 1, wherein the tray is formed with a plurality of slots into which the plurality of clean transparent layers is placed.

5. The method according to claim 1, wherein the frame is a frame for typical wafer slicing.
